(19) United States
(12) Patent Application Publication
(10) Pub. No.: US 2014/0225739 A1
(43) Pub. Date: Aug. 14, 2014

(54) ENERGY CONSUMPTION ALARM METHOD AND A DISPLAY THEREOF

(71) Applicant: Wistron Corporation, New Taipei City (TW)

(72) Inventor: CHENG-SHENG WENG, New Taipei City (TW)

(73) Assignee: Wistron Corporation, New Taipei City (TW)

(21) Appl. No.: 14/079,336

(22) Filed: Nov. 13, 2013

(30) Foreign Application Priority Data
Feb. 8, 2013 (TW) 102105436

(51) Int. Cl. G08B 21/18

(52) U.S. Cl. CPC G08B 21/182
USPC 340/635

(57) ABSTRACT

An energy consumption alarm method and a display thereof are disclosed. The method is applied for determining whether the energy consumption of a display complies with an energy consumption regulation or not. The energy consumption alarm method includes the following steps: generating a backlight value; detecting an output volume; determining whether the backlight value is greater than a backlight threshold according to the energy consumption regulation and the output volume; and if the backlight value is greater than the backlight threshold, the displaying a alarm signal.

### BACKGROUND OF THE DISCLOSURE

1. Field of the Disclosure

The present disclosure relates to an energy consumption warning method and a display thereof, particularly an energy consumption warning method and a display issuing a warning when an energy consumption of the display exceeds an energy consumption regulation.

2. Description of the Related Art

With increased awareness of environmental protection, consumers are increasingly aware of the power consumption of electronic goods and increasingly prefer electronic goods with low power consumption. Currently, passive light-emitting displays such as liquid crystal displays or light-emitting diode (LED) displays are equipped with a backlight module that functions as a light source for the display panel to achieve a purpose of displaying images. Referring to the power consumption of a display, the backlight module consumes a considerable amount of the total power consumption; i.e., it sometimes accounts for one-third to half of the total power consumption.

Recently, an energy consumption regulation employed for monitoring the energy consumption of a display is the ENERGY STAR regulation of the U.S. Environmental Protection Agency (EPA). The latest version is ENERGY STAR 6.0, which sets tight restrictions on the energy consumption of displays. To comply with the regulations of ENERGY STAR 6.0, the energy consumption of the display must be very low, and the power consumption of the backlight module in particular has to be reduced. However, compliance with the regulations of ENERGY STAR 6.0 for the power consumption of a display may create the conditions of inadequate backlight and a dark screen, causing inconvenience to the user.

### SUMMARY OF THE DISCLOSURE

An object of the present disclosure is to provide a alarm method for informing a user about an energy consumption state of a display while the backlight of the display is being adjusted.

Another object of the present disclosure is to provide a alarm method for issuing a alarm signal when the energy consumption state of the display exceeds an energy consumption regulation.

Further another object of the present disclosure is to provide a display capable of issuing a alarm signal when the energy consumption state of the display exceeds an energy consumption regulation.

In order to achieve the above objects, an energy consumption alarm method and a display thereof are disclosed. The energy consumption alarm method is applied for determining whether the energy consumption of a display is below an energy consumption regulation or not. The energy consumption alarm method comprises the following steps: generating a backlight value; detecting an output volume; determining whether the backlight value is greater than a backlight threshold according to the energy consumption regulation and the output volume; and if the backlight value is greater than the backlight threshold, displaying a alarm signal.

According to an embodiment of the present disclosure, the energy consumption alarm method further comprises the following steps before generating the backlight value: triggering the display into a backlight adjustment mode; displaying a default backlight value in a first color; receiving a backlight adjustment signal; and generating the backlight value according to the backlight adjustment signal.

According to an embodiment of the present disclosure, the alarm signal is presented in the form of the display module displaying the backlight value in a second color.

According to an embodiment of the present disclosure, if the backlight value is less than a backlight threshold, the backlight value is displayed in the first color.

According to an embodiment of the present disclosure, the alarm signal comprises a text, an image, or a sound message.

The present disclosure further provides a display that comprises a display module, a sound output module, a processor, and a memory. The processor is electrically connected with the display module and the sound output module; the memory is electrically connected with the processor for storing a plurality of instructions; the processor implements the plurality of instructions to perform the mechanisms of generating a backlight value, detecting an output volume, determining whether the backlight value is greater than a backlight threshold according to the energy consumption regulation and the output volume, and if the backlight value is greater than the backlight threshold, displaying a alarm signal.

According to an embodiment of the present disclosure, the alarm signal is presented in the form of the display module displaying the backlight value in a second color.

According to an embodiment of the present disclosure, the display module comprises a first display region and a second display region; when the backlight value is less than or equal to the backlight threshold, the first color is displayed in the first display region; when the backlight value is greater than the backlight threshold, the second color is displayed in the second display region.

According to an embodiment of the present disclosure, the alarm signal comprises a text, an image, or a sound message.

### BRIEF DESCRIPTION OF THE DRAWINGS

The exemplary embodiment of the present disclosure will be understood more fully from the detailed description given below and from the accompanying drawings of the disclosure, which, however, should not be taken to limit the disclosure to the specific embodiment but are for explanation and understanding only.

FIG. 1 is a diagram of the hardware architecture of the display of the present disclosure.

FIG. 2 is a step flowchart of the energy consumption alarm method of the present disclosure.

FIG. 3 is the reference diagram of the backlight threshold corresponding to different output volumes of the energy consumption alarm method of the present disclosure.

FIG. 4 is a schematic diagram of the backlight value of the display of the present disclosure.

FIG. 5 is another schematic diagram of the backlight value of the display of the present disclosure.

FIG. 6 is a schematic diagram of the display of the present disclosure showing alarm signals.

### DETAILED DESCRIPTION OF THE PREFERRED EMBODIMENT

To facilitate understanding and to clarify the object, characteristics and advantages of the present disclosure, the following specific embodiment and figures illustrating the present disclosure are presented to provide a detailed description.

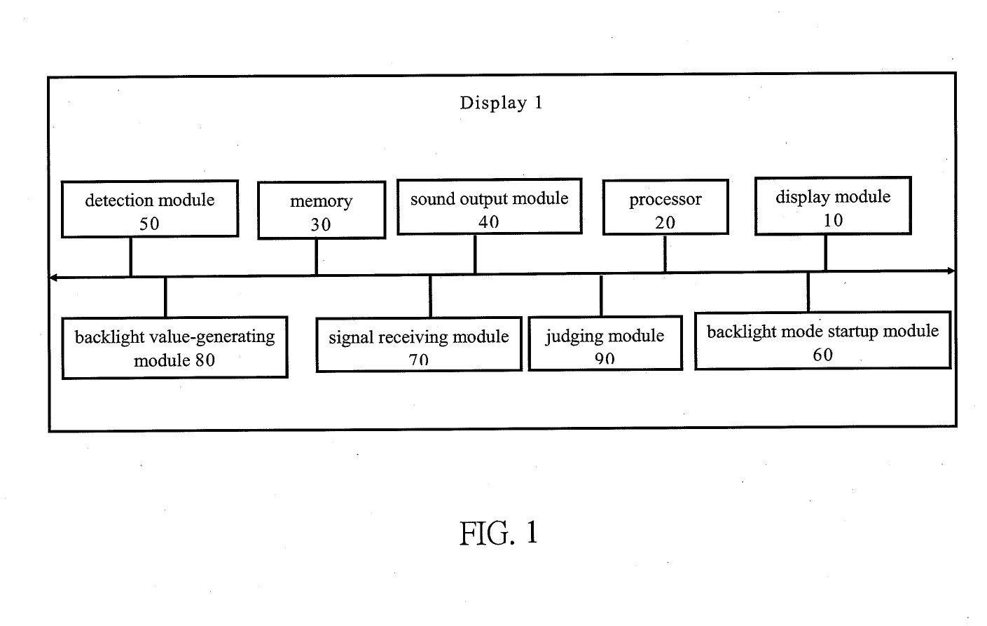

Please refer to FIG. 1, which is a diagram of the hardware architecture of the display of the present disclosure. The display 1 of the present disclosure comprises a display module 10, a processor 20, a memory 30, a sound output module 40, a detection module 50, a backlight mode startup module 60, a signal receiving module 70, a backlight value-generating module 80, and a judging module 90. The display module 10 is a 32-inch light-emitting diode display module in this embodiment, but the present disclosure is not limited to this. The display module 10 can be a light-emitting diode display module, an LCD module, or other passive light-emitting display modules of various sizes. The processor 20 of the present embodiment is a control chip for performing operations of the display 1. The processor 20 is electrically connected to the display module 10 and the sound output module 40. In the present embodiment, the sound output module 40 is a speaker of the display 1. The memory 30 and the processor 20 are electrically connected. The memory 30 stores a plurality of instructions. The processor 20 reads the plurality of instructions to perform the following mechanisms: generating a backlight value 200 by the backlight value-generating module 80; detecting the output volume 100 of the sound output module 40 by the detection module 50; determining whether the backlight value is greater than a backlight threshold 210 or not by a judging module 90 according to the energy consumption regulation and the output volume; and, if so, the display module 10 displaying a alarm signal. It is noted that the aforementioned modules can be configured not only as hardware devices, software programs, firmware, or a combination thereof but also as a circuit loop or other suitable forms.

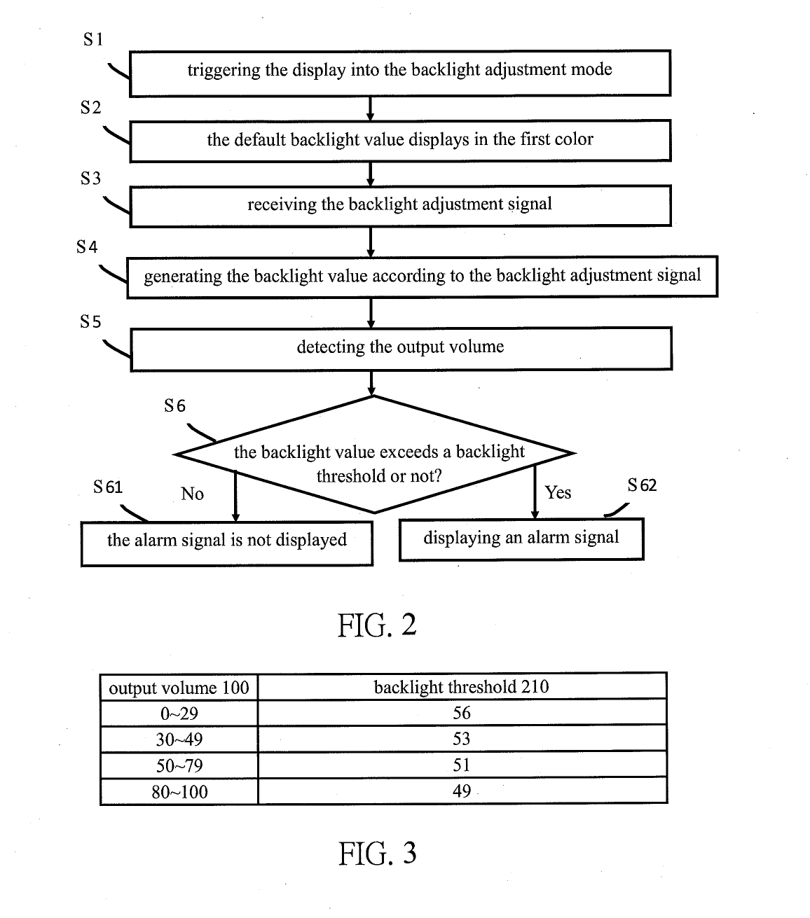

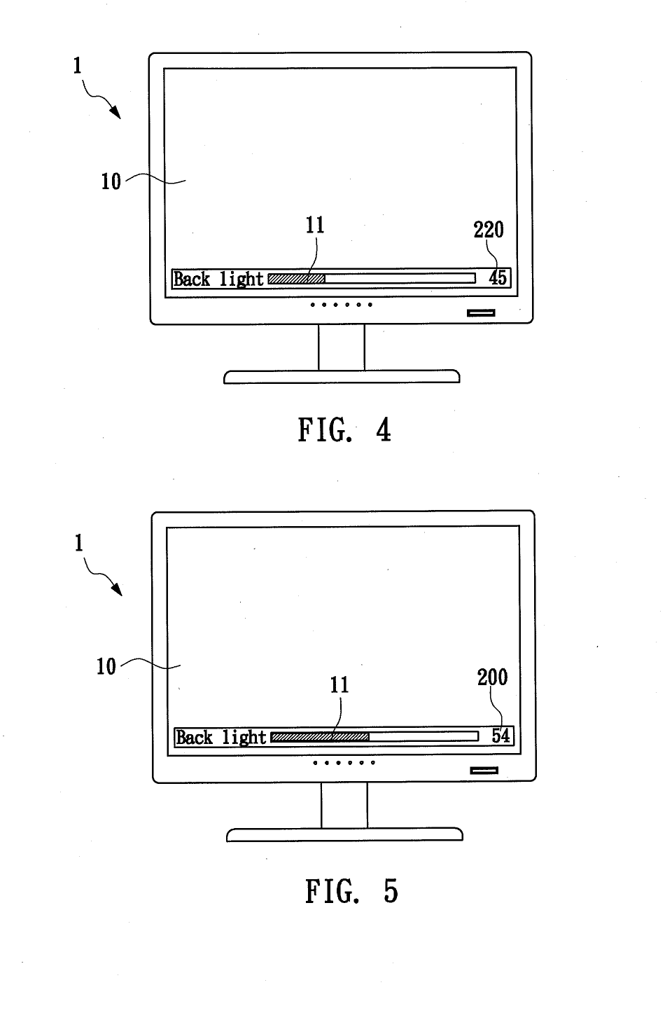

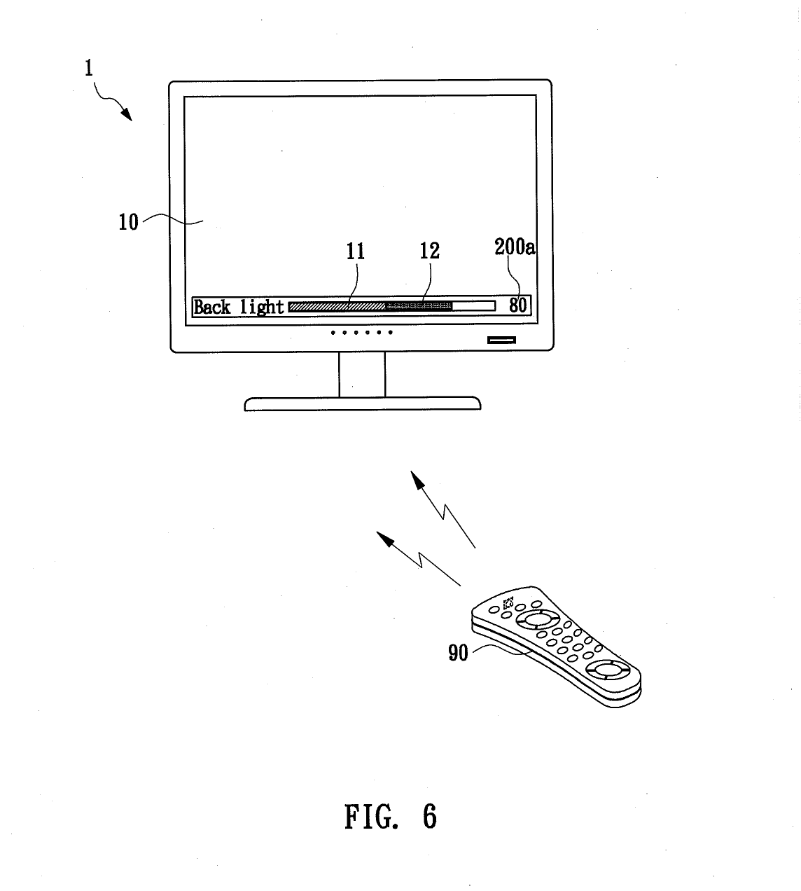

Please continue to refer to FIG. 1 to FIG. 6 to understand the flow of steps of the energy consumption alarm method of the present disclosure, wherein FIG. 2 is a step flowchart of the energy consumption alarm method of the present disclosure. FIG. 3 is a reference diagram of the backlight threshold corresponding to different output volumes in the energy consumption alarm method of the present disclosure. FIGS. 4 and 5 are schematic diagrams of the backlight value of the display of the present disclosure. FIG. 6 is a schematic diagram of a display of the present disclosure showing alarm signals.

The energy consumption alarm method of the present disclosure is applied for detecting whether the power consumption of a display 1 exceeds an energy consumption regulation or not. In this embodiment, the energy consumption regulation refers to the Energy Star 6.0 energy consumption regulation. While the display 1 is operating, the backlight module of the display module 10 and the sound output module 40 are two components that consume large quantities of power. Therefore, to make the display 1 operate in compliance with the Energy Star 6.0 energy consumption regulation, the power consumption of the backlight module and that of the sound output module 40 of the display module 10 must be considered together. Thus, before applying the energy consumption alarm method of the present disclosure to detect the energy consumption of the display 1, technicians have to measure a backlight threshold 210 for the display module 10 while the display 1 outputs various output volumes 100 to ensure that the energy consumption of the display 1 complies with the Energy Star 6.0 energy consumption regulation through experiments, and then the technicians have to complete a contrast table. The table is stored in the display 1 for use as an energy consumption standard for monitoring whether the energy consumption of the display 1 exceeds the Energy Star 6.0 energy consumption regulation.

In the present embodiment, as shown in FIG. 3, the contrast table has recorded the backlight threshold 210 for the display module 10 when the display 1 outputs various output volumes 100 to ensure that the energy consumption of the display 1 complies with Energy Star 6.0. It is noted that different specifications of the displays 1 (such as a 32-inch LCD display or a 34-inch LED display) have different backlight thresholds. The backlight threshold values shown in FIG. 3 are provided as examples, and the actual backlight threshold values of displays with different specifications can only be confirmed by technical personnel who perform experimental measurements for individual displays 1.

As shown in FIG. 2, the energy consumption alarm method of the present disclosure comprises the following steps:

Step S1: triggering the display into the backlight adjustment mode.

When watching a movie or program on the display 1, the user may feel that the backlight brightness of the display 1 is too dark and needs to be adjusted. As shown in FIG. 4, the backlight mode startup module 60 can be triggered by pressing the backlight adjustment button on a remote controller 100 or on the display 1 to cause the display 1 to enter a backlight adjustment mode.

Step S2: the default backlight value displayed in the first color.

In the present embodiment, as shown in FIG. 4, after the display 1 enters the backlight adjustment mode, the default backlight value 220 is shown in the first display region 11 of the display module 10. The default backlight value 220 is the backlight brightness value built into the display 1 for various displaying scenarios. For example, if the displaying scenario of the current display 1 is a vivid mode and the default backlight brightness value built in the display 1 is 45 under the vivid mode, then the display region 11 will show 45 in the first color after the display 1 enters the backlight adjustment mode.

It is noted that all the default backlight values built into the display 1 comply with the Energy Star 6.0 energy consumption regulation. When the display 1 displays different displaying scenarios, different default backlight values 220 are built into the display 1 for corresponding to each displaying scenario. The default backlight value 220 in FIG. 5 is presented only for illustrative purposes.

Step S3: receiving a backlight adjustment signal.

After the default backlight value 220 is displayed in the first display region 11, in this embodiment, as shown in FIG. 4, the signal receiving module 70 receives the backlight adjustment signal 110 emitted by the user through the remote control 90. It is noted that the backlight adjustment signal 110 can also be generated by pressing the backlight adjustment button on the display 1.

Step S4: generating the backlight value according to the backlight adjustment signal.

The backlight value-generating module 80 generates the backlight value 200 according to the backlight adjustment signal. In the present embodiment, as shown in FIGS. 4 and 5, the backlight adjustment signal 110 increases the backlight brightness of the display module 10; therefore, the backlight value-generating module 80 increases the backlight value 200 from 45 to 54 according to the backlight adjustment signal.

Step S5: detecting the output volume.

While the backlight value 200 of the display module 10 is increasing, the detection module 50 also detects the output volume 100 of the sound output module 40. In the present embodiment, it is assumed that the output volume 100 of the sound output module 40 detected by the detection module 50 is 25.

Step S6: determining whether the backlight value exceeds a backlight threshold according to the energy consumption regulations and the output volume.

If not, then step S61 is performed.

If yes, then step S62 is performed.

As described in Step S5, in the present embodiment, the output volume 100 of the display 1 detected by the detection module 50 is 25, and the judging module 80 can determine the backlight value 200 of the display module 10 in FIG. 5 does not exceed the backlight threshold value 210 according to the contrast table in FIG. 3. From the contrast table in FIG. 3, it can be known that when the output volume 100 is 25, the backlight threshold 210 of the display 10 is 56. In FIG. 5, the backlight value 200 is 54, less than the backlight threshold value 210. This situation can also represent that the power consumption of the display 1 does not exceed the Energy Star 6.0 energy consumption regulation.

It is noted that the first display region 11 is the display area when the default backlight value 220 and the backlight value 200 of the display module 10 are less than the backlight threshold 210. The longer the length of the first color in the first display region 11, the greater the backlight value 220 will be, as shown in FIGS. 4 and 5. As long as the backlight value 220 is lower than the backlight threshold 210, the backlight value 220 of the display module 10 will be shown in the first display region 11 in the first color.

Step S61: the alarm signal is not displayed.

After the determination of the judging module 80, in the state where the output volume 100 of the display 1 is 25, the backlight value 200 of the display module 10 shown in FIG. 5 does not exceed the backlight threshold value 210, so it is not needed for the display 1 to issue the alarm signal. In this case shown in FIG. 5, the backlight value 200 is still displayed in the first display region 11 in the first color.

Step S62: displaying an alarm signal.

As shown in FIG. 6, in the present embodiment, if the output volume 100 of the display 1 detected by the detection module 50 is still 25, and the backlight value 200a shown in FIG. 6 is 80, the judging module 80 determines that the backlight value 200a shown in FIG. 6 has exceeded the backlight threshold 210 according to the contrast table in FIG. 3. At that time, the display module 10 shows a alarm signal to inform the user that the current power consumption of the display 1 exceeds the Energy Star 6.0 energy consumption regulation. As shown in FIG. 6, in the present embodiment, the alarm signal is displayed in the second color to show the parts in the backlight value 200a exceeding the backlight threshold 210 in the second display region 12, while the other parts less than or equal to the backlight threshold 210 are displayed in the first display region 11.

It is noted that the energy consumption alarm method in the present disclosure is only applied for alarm and informing the user. The user can decide whether to reduce the backlight brightness of the display module 10 to comply with the Energy Star 6.0 energy consumption regulation. Also, if the previous display 1 operates with a backlight brightness higher than the Energy Star 6.0 energy consumption regulation, then when the display 1 is turned off and then turned on again, the display 1 will automatically adjust the backlight brightness of the display module 10 downward to comply with the Energy Star 6.0 energy consumption regulation.

In addition, the display of different colors as alarm signals is only one embodiment of the present disclosure, and the present disclosure is not limited to this embodiment. The alarm signals emitted by the display 1 can be rendered as text, an image, or a sound message.

In summary, regardless of the purposes, means and effectiveness, this disclosure has characteristics that are quite different from those of known technology. It is noted that many of the above-mentioned embodiments are only for illustrative purposes and that the claims of this disclosure should depend on the claims rather than being limited to the embodiments. Any professional who is skilled in the art can modify and change the embodiments in the case without violating the technical principles and spirit of the present disclosure. The protected rights will be as described later in the claims.

What is claimed is:

1. An energy consumption alarm method for monitoring whether an energy consumption of a display complies with an energy consumption regulation or not, wherein the display comprises a display module and an energy consumption alarm method comprising the following steps:
generating a backlight value;
detecting an output volume;
determining whether the backlight value is greater than a backlight threshold according to the energy consumption regulation and the output volume; and
if so, the display module displaying a alarm signal.

2. The energy consumption alarm method as claimed in claim 1, wherein the energy consumption alarm method further comprises the following steps before generating the backlight value:
triggering the display into a backlight adjustment mode;
displaying a default backlight value in a first color;
receiving a backlight adjustment signal; and
generating a backlight value according to the backlight adjustment signal.

3. The energy consumption alarm method as claimed in claim 2, wherein the alarm signal is presented in the form of the display module displaying the backlight value in a second color.

4. The energy consumption alarm method as claimed in claim 3, wherein the step for determining whether the backlight value is greater than a backlight threshold according to the energy consumption regulation and the output volume energy consumption regulation further comprises the following step:
if not, the backlight is displayed in the first color.

5. The energy consumption alarm method as claimed in claim 4, wherein the alarm signal comprises a text, an image, or a sound message.

6. The energy consumption alarm method as claimed in claim 1, wherein the step for determining whether the backlight value is greater than a backlight threshold according to the energy consumption regulation and the output volume energy consumption regulation further comprises the following step:
if not, the backlight is displayed in the first color.

7. The energy consumption alarm method as claimed in claim 6, wherein the alarm signal comprises a text, an image, or a sound message.

8. A display, comprising:
a display module;
a sound output module;
a processor electrically connected with said display module and said sound output module; and
a memory electrically connected with the processor for storing a plurality of instructions, the processor implementing the plurality of instructions to perform the following mechanisms:
generating a backlight value via a backlight value-generating module;
detecting an output volume outputted by the sound output module via a detection module;
determining whether the backlight value is greater than a backlight threshold according to the energy consumption regulation and the output volume; and,
if so, the display module displaying a alarm signal.

9. The display as claimed in claim 8, wherein the alarm signal is presented in the form of the display module displaying the backlight value in a second color.

10. The display as claimed in claim 9, wherein the display module comprises a first display region and a second display region; when the backlight value is less than or equal to the backlight threshold, the first color is displayed in the first display region; when the backlight value is greater than the backlight threshold, the second color is displayed in the second display region.

11. The display as claimed in claim 10, wherein the alarm signal comprises a text, an image, or a sound message.

12. The display as claimed in claim 8, wherein the display module comprises a first display region and a second display region; when the backlight value is less than or equal to the backlight threshold, the first color is displayed in the first display region; when the backlight value is greater than the backlight threshold, the second color is displayed in the second display region.

13. The display as claimed in claim 12, wherein the alarm signal comprises a text, an image, or a sound message.
